(19) United States
(12) Patent Application Publication
(10) Pub. No.: US 2026/0020549 A1
(43) Pub. Date: Jan. 22, 2026

(54) FISHING LURE

(71) Applicant: Travis McClure, Chelan Falls, WA (US)

(72) Inventor: Travis McClure, Chelan Falls, WA (US)

(21) Appl. No.: 19/266,006

(22) Filed: Jul. 10, 2025

Related U.S. Application Data
(60) Provisional application No. 63/672,179, filed on Jul. 16, 2024.

(51) Int. Cl. A01K 85/12; A01K 85/00; A01K 85/01

(52) U.S. Cl. CPC A01K 85/12; A01K 85/018; A01K 85/019; A01K 85/1837

(57) ABSTRACT

Systems for a fishing lure are disclosed, where the fishing lure includes a body with bends and/or twists and a plurality of holes formed into the body. The plurality of holes is oriented to prevent intersection between a leader hole and a tube adapted to hold bait or weighted pellets such that spinning of the fishing lure is increased.

### CROSS REFERENCE TO RELATED APPLICATIONS

The present application claims priority to U.S. Provisional Application No. 63/672,179 entitled FISHING LURE, and filed on Jul. 16, 2024. The entire contents of each of the above-referenced application(s) are hereby incorporated by reference for all purposes.

### TECHNICAL FIELD

The present description relates generally to fishing lures, and more particularly to fishing lures with twisted and bent bodies.

### BACKGROUND AND SUMMARY

Fishing lures are generally used to attract fish, in some examples a certain type of fish. Thus, the fishing lures may be designed to hold bait exuding a scent appealing to the fish, and to move in a desirable manner, including spinning, when placed in water. Some prior examples of fishing lures may not be adequately shaped to move in such ways. Additionally, some prior fishing lures may be excessively complex with two or more individual pieces joined by hinges, fasteners, snap-fitting interfaces and other features prone to degradation. Moreover, prior art fishing lures may be configured with a hole for a leader to extend therethrough and a hole for holding bait or weighted pellets, where the holes may intersect. Due to such an intersection, the leader may be impinged by the bait or weighted pellets, thereby hindering spinning action of the lure.

Thus, embodiments are disclosed herein that solve at least some of the issues described above with a fishing lure comprising a body and a plurality of holes formed into the body The body may be twisted to form a twisted ribbon or corkscrew shape. Additionally or alternatively, the body may be bent. In this way, a shape of the body may increase desired movement such as spinning of the fishing lure of the present disclosure. Further, the plurality of holes may include a leader hole and a tube, where the leader hole may be protected from bait or weighted pellets placed in the tube such that interference with the leader is prevented. Further still, the fishing lure of the present disclosure may comprise a single continuous piece without fasteners such as hinges, clips, snap-fitting interfaces, or the like, and thus may be more durable. The fishing lure of the present disclosure may also be more simply constructed, for example by three-dimensional (3D) printing the single continuous piece.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIGS. 1A-1D show perspective views of a lure in accordance with the present disclosure.

FIGS. 2A-2D show views of a lure body.

FIGS. 3A-3C show views of a lure body.

FIGS. 4A-4C show views of a lure body.

FIGS. 5A-5D show views of a twisted lure body.

FIGS. 6A-6C show views of a twisted lure body.

FIGS. 7A-7D show views of a bent and twisted lure body.

FIGS. 8A-8D show views of a bent and twisted lure body.

FIGS. 9A-9D show views of a leader hole.

FIGS. 10A-10D show views of a tube.

FIGS. 11A-11D show views of scent windows.

FIGS. 12A-12D show views of ballast voids.

FIGS. 13A-13D show views of a lure in accordance with the present disclosure.

FIGS. 14A-14B show views of leading edges of the lure.

FIG. 15 shows an enlarged view of a shielded leader hole.

### DETAILED DESCRIPTION

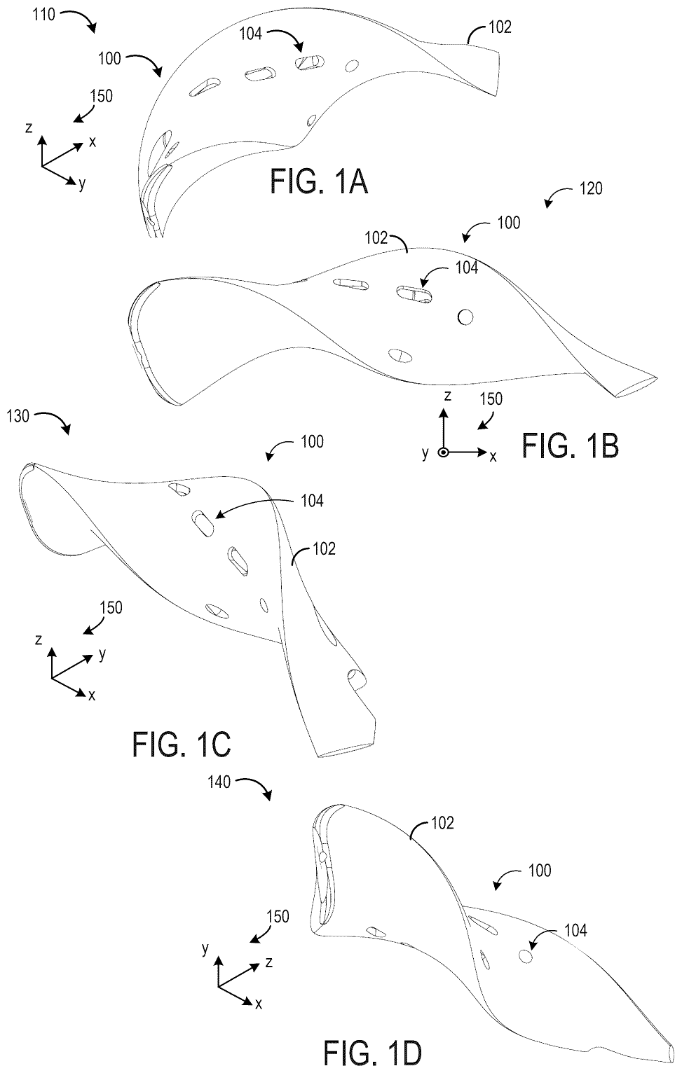

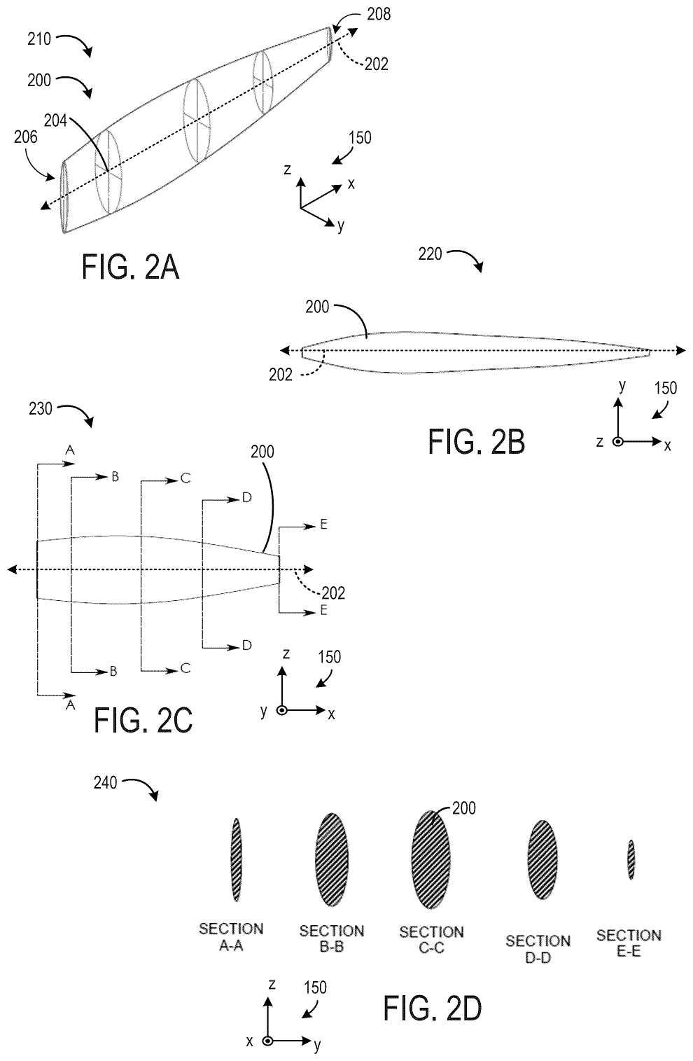

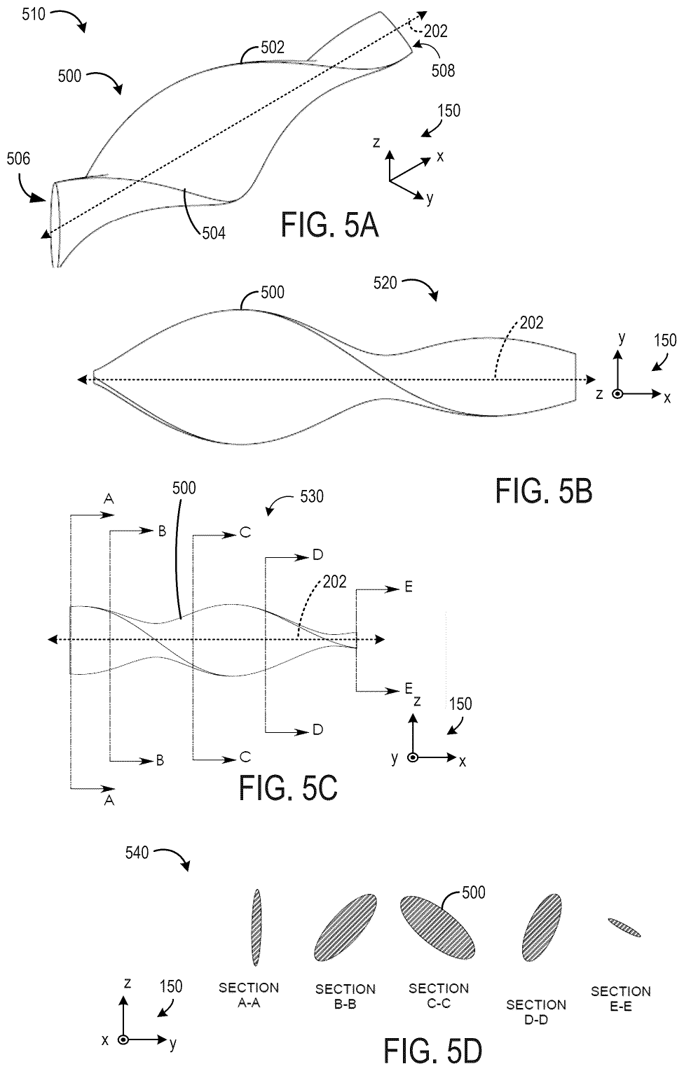

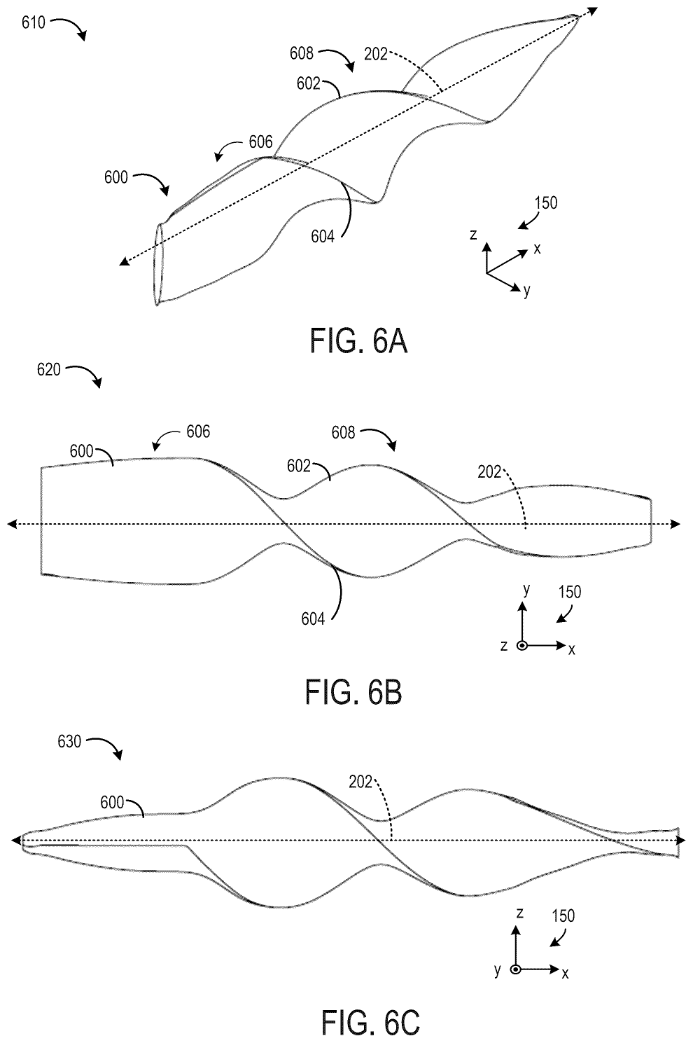

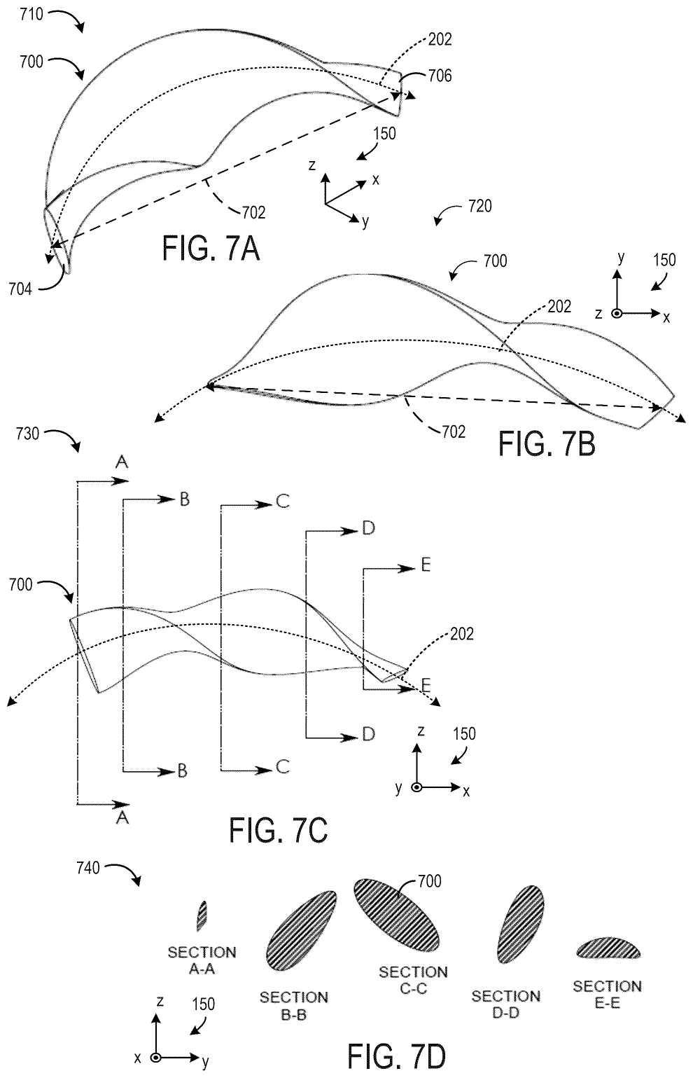

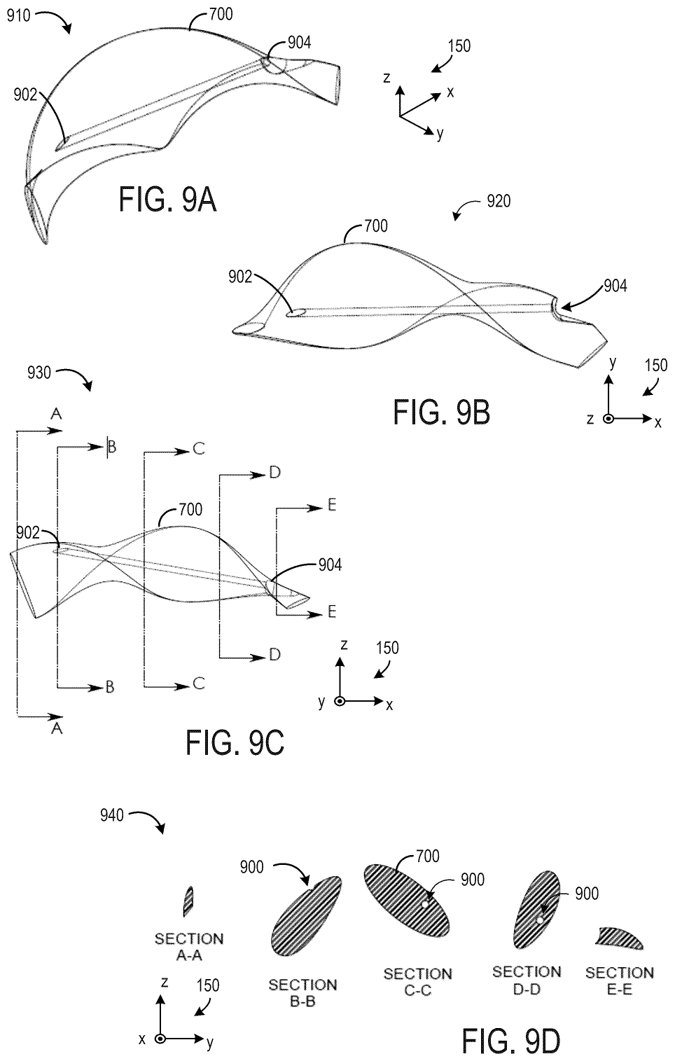

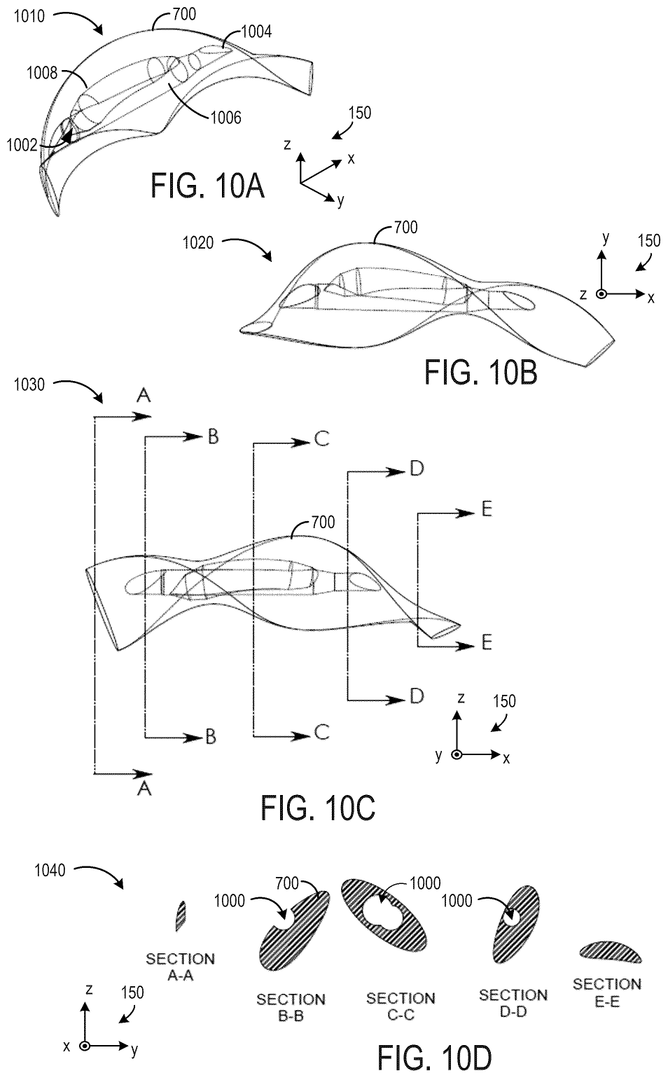

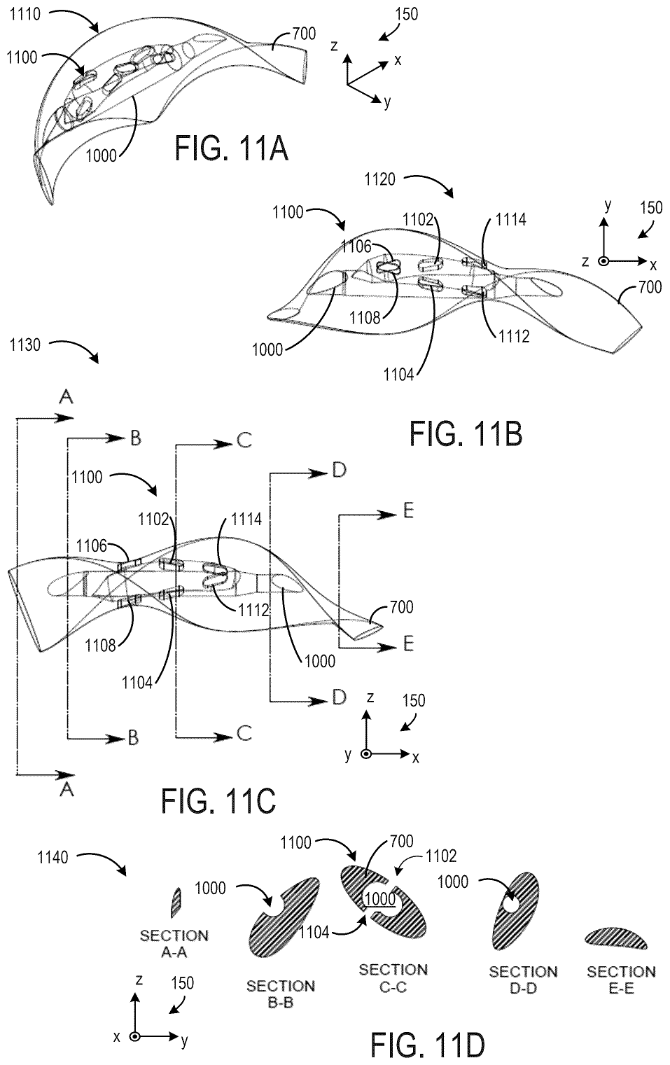

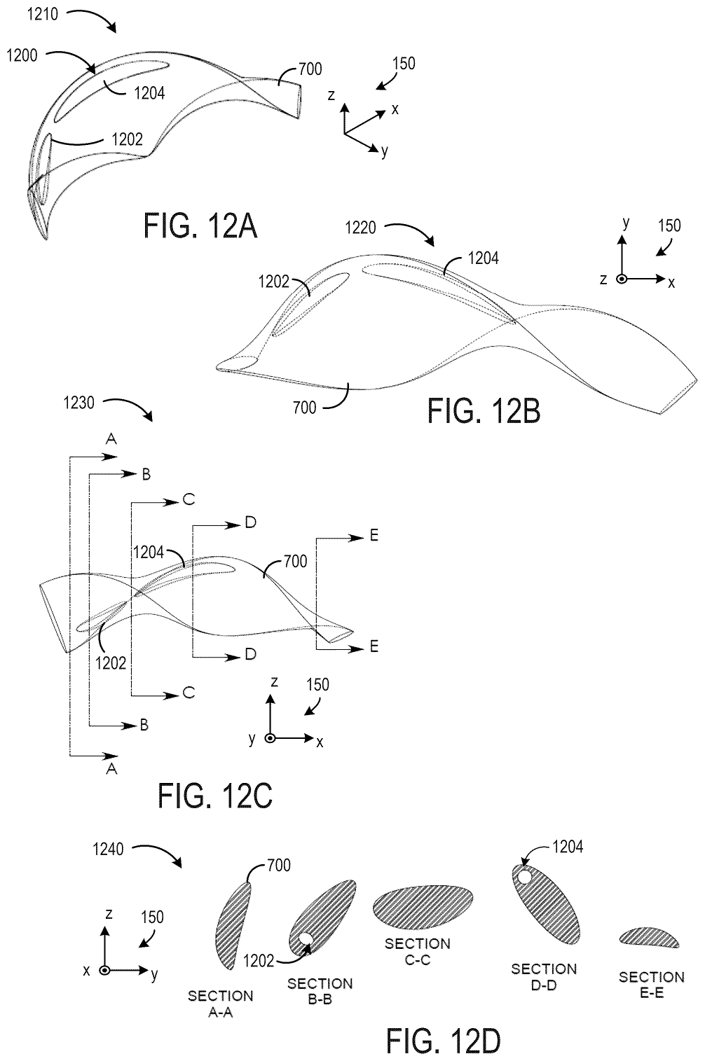

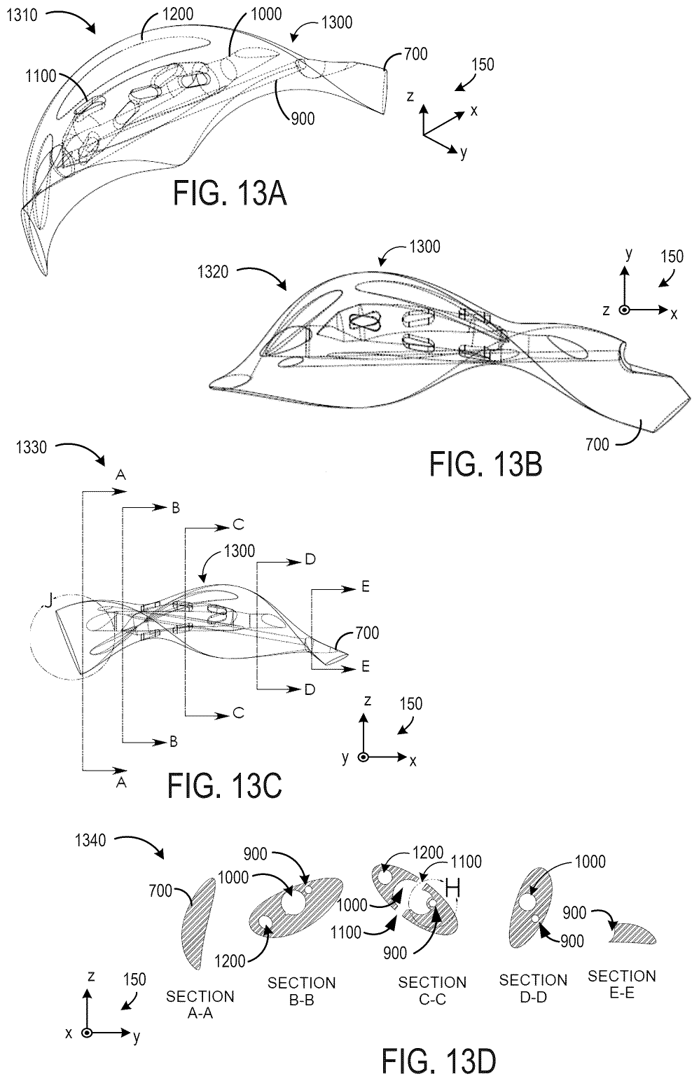

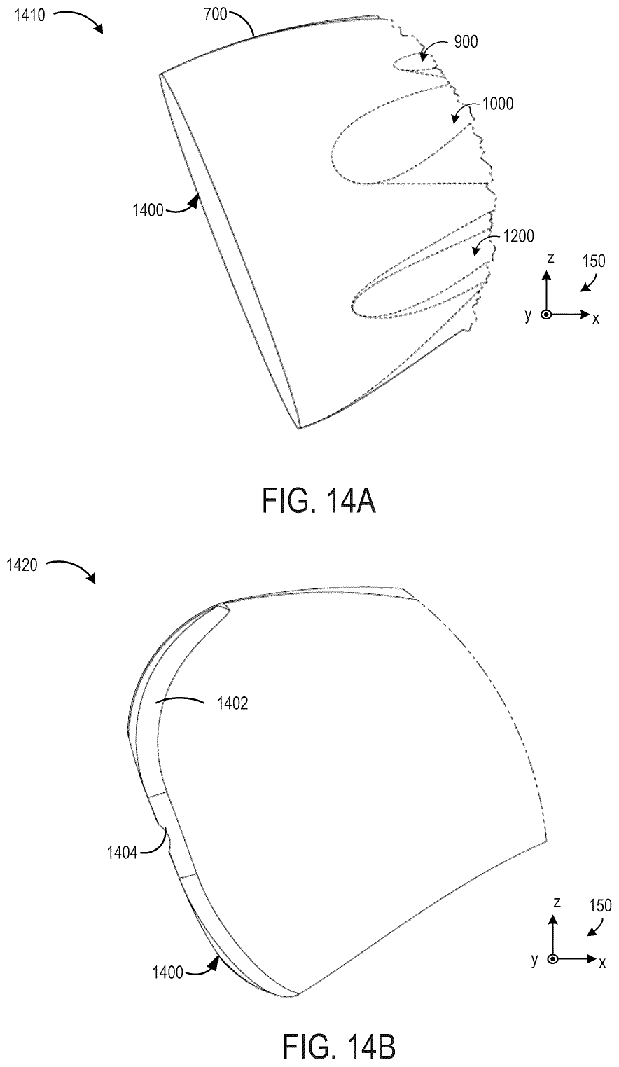

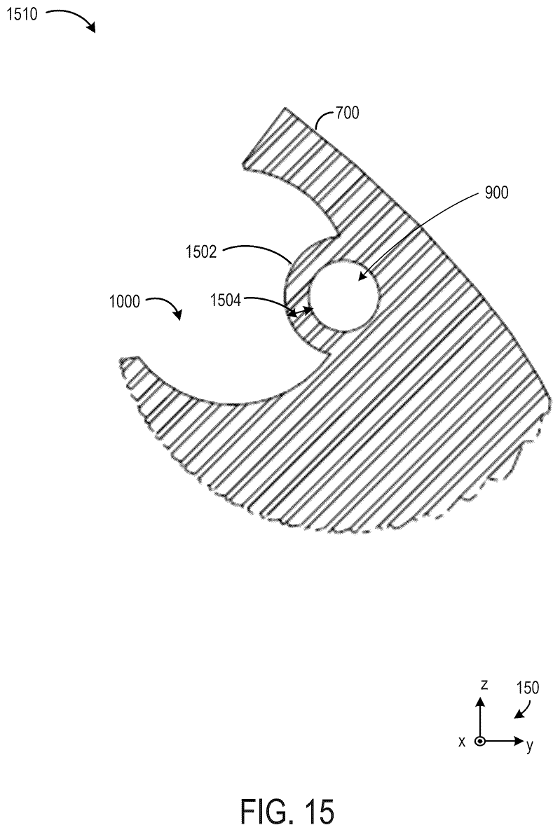

The following description relates to systems for fishing lures. A lure in accordance of the present disclosure, such as the lure shown in FIGS. 1A-1D, may comprise a body with bends and/or twists and a plurality of holes extending therethrough. Examples of unbent, untwisted body shapes are shown in FIGS. 2A-4C. Examples of twisted body shapes are shown in FIGS. 5A-6C. Examples of bent and twisted body shapes are shown in FIGS. 7A-7D. Including bends and/or twists in a shape of the lure may allow the lure to more similarly mimic movement of a fish in water during use. Further, the plurality of holes may be designed and positioned such that undesired interference therebetween is prevented. The plurality of holes may include both through holes and blind holes, as well as closed cavities. For example, the plurality of holes may include a leader hole such as shown in FIGS. 9A-9D, a tube such as shown in FIGS. 10A-10D, one or more scent windows such as shown in FIGS. 11A-11D, and a ballast void including one or more cavities as shown in FIGS. 12A-12D. FIGS. 13A-13D show a lure in accordance with the present disclosure comprising the plurality of holes described with regards to FIGS. 9A-12D. Details of a leading edge of the lure are provided in FIGS. 14A-14B. FIG. 15 shows how the leader hole may be shielded from intersection with other openings due to orientations of the plurality of holes to prevent interference with spinning action of the lure during use.

It is to be understood that the specific assemblies and systems illustrated in the attached drawings, and described in the following specification are exemplary embodiments of the inventive concepts defined herein. For purposes of discussion, the drawings are described collectively. Thus, like elements may be commonly referred to herein with like reference numerals and may not be re-introduced.

Turning to FIGS. 1A, 1B, 1C, and 1D, a lure 100 in accordance with the present disclosure is shown in perspective views 110, 120, 130, and 140, respectively. A set of reference axes 150, including an x-axis, a y-axis, and a z-axis, are shown in FIGS. 1A-15 for comparison of orientations in the views shown.

The lure 100 may include a body 102, where the body 102 may have a fish-shaped profile shaped with bends and/or twists. A fish-shaped body may include oval-shaped cross sections forming a nearly flat, rounded shape with tapered ends. In some examples, a fish-shaped body may include widenings, or wings, resembling fish fins where the oval-shaped cross sections are oriented with non-parallel maximal diameters. In other examples, the body may differ from a fish shape. Further details as to fish body shapes are described in regards to FIGS. 2A-4D, and modifications to such fish-shaped bodies including bends and twists are described with regards to FIGS. 5A-8D. Further, there may be a plurality of holes 104 formed into the body 102, as described in regards to FIGS. 9A-12D. For example, the plurality of holes 104 may include a leader hole, a tube, a scent window, and a ballast void. The plurality of holes 104 may include through holes, blind holes, closed cavities, and the like. The plurality of holes 104 may be positioned such that the leader hole is shielded, or separated from other holes, as described in regards to FIG. 15. Further still, a leading edge of the lure may take different shapes, for example according to a desired movement of the lure 100 in water, as described with regards to FIGS. 14A and 14B. The lure 100 may consist of a single continuous piece. For example, the lure 100 may be constructed as a single continuous piece of plastic by 3D printing.

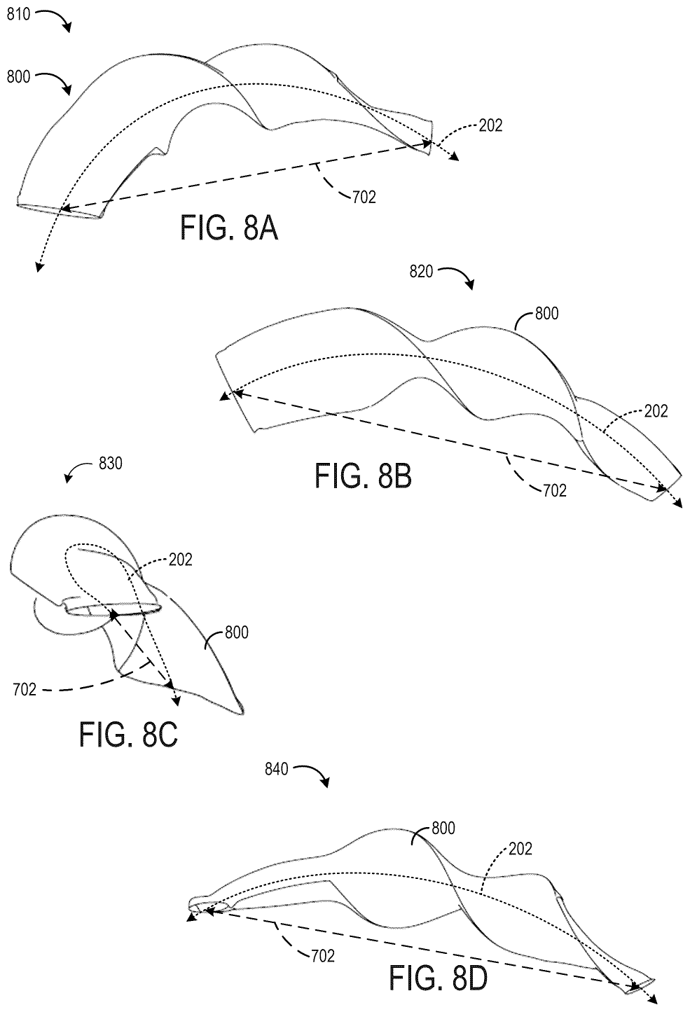

Turning to FIGS. 2A, 2B, 2C, and 2D, a lure body 200 is shown in perspective view 210, top view 220, side view 230, and cross section view 240, respectively. The lure body 200 may include cross sections in y-z planes, such as section A-A, section B-B, section C-C, section D-D, and section E-E shown in FIG. 2D. The lure body 200 may include oval shaped-cross sections, as shown. For example, the cross sections may be elliptical. In other examples, the cross sections may be other rounded shapes. The lure body 200 may be centered about a central axis 202 linearly extending parallel with the x-axis through centers 204 of the cross sections. Thus, the cross sections may be centered along the central axis 202. Further, the central axis 202 may be collinear with a straight line extending from a center of a first end 206 of the body 200 to a center of a second end 208 of the body 200. In other words, the central axis 202 may be a straight line extending from the center of the first end 206 to the center of the second end 208, and thus the lure body 200 may be described herein as unbent. In contrast, a bent lure body, such as the examples shown in FIGS. 7A-8D, may be centered about a bent or rounded axis, rather than extending linearly through an unbent lure body. An unbent, untwisted lure body, such as the body 200 may be nearly flat and have a profile resembling a fish. However, other shapes may be modified by bending or twisting into a lure of the present disclosure.

The body 200 may have varying dimensions along the central axis 202. Maximal diameters of the cross sections may be parallel and minimal diameters of the cross sections may be parallel. The maximal diameters and minimal diameters may vary along a length (e.g., dimension perpendicular to the cross sections) of the lure body 200. In this way, the lure body 200 may be shaped similarly to a fish. For example, cross sections of ends of the lure body 200 may be smaller in area than cross sections in a midsection of the lure body 200 such that the ends of the lure body 200 may be tapered. However, in some examples, ends of the lure body may be wider than the midsection, rather than the lure body having tapered ends narrower than the midsection.

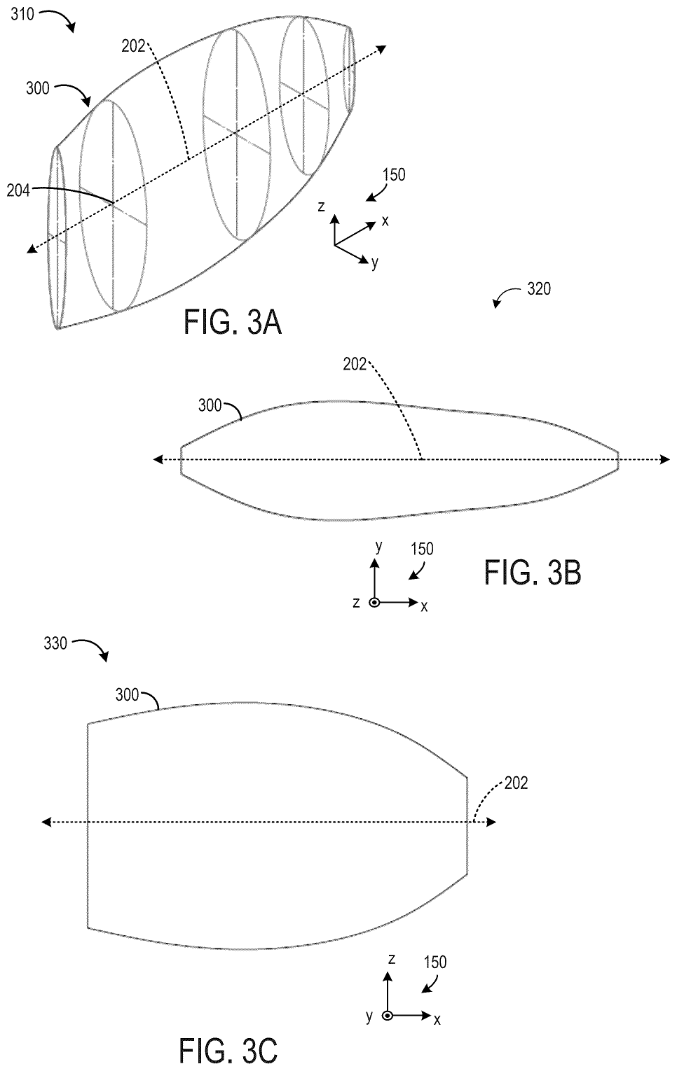

Turning to FIGS. 3A, 3B, and 3C, another example of a lure body 300 is shown in perspective view 310, top view 320, and side view 330, respectively. The lure body 300 may include oval shaped-cross sections, as shown. For example, the cross sections may be elliptical. In other examples, the cross sections may be other rounded shapes. The lure body 300 is similar to the lure body 200 of FIGS. 2A-2D in that cross sections of a variety of sizes form tapered ends and a wide midsection. Like the lure body 200 of FIGS. 2A-2D, the central axis 202 extends linearly through a center of the lure body 300 by intersecting the centers 204 of the cross sections perpendicular to the central axis 202 (e.g., in y-z planes). Thus, the lure body 300 may be described herein as unbent. The lure body 300 has different relative dimensions of the cross sections, resulting in a different overall shape. For example, the lure body 200 may be more elongated than the lure body 300. Thus, dimensions of the body of a lure in accordance with the present disclosure may be adjusted to resemble different types of fish. An unbent, untwisted lure body such as the lure body 300 may be roughly flat and have a profile resembling a fish. However, other shapes are possible without departing from the scope of the present disclosure.

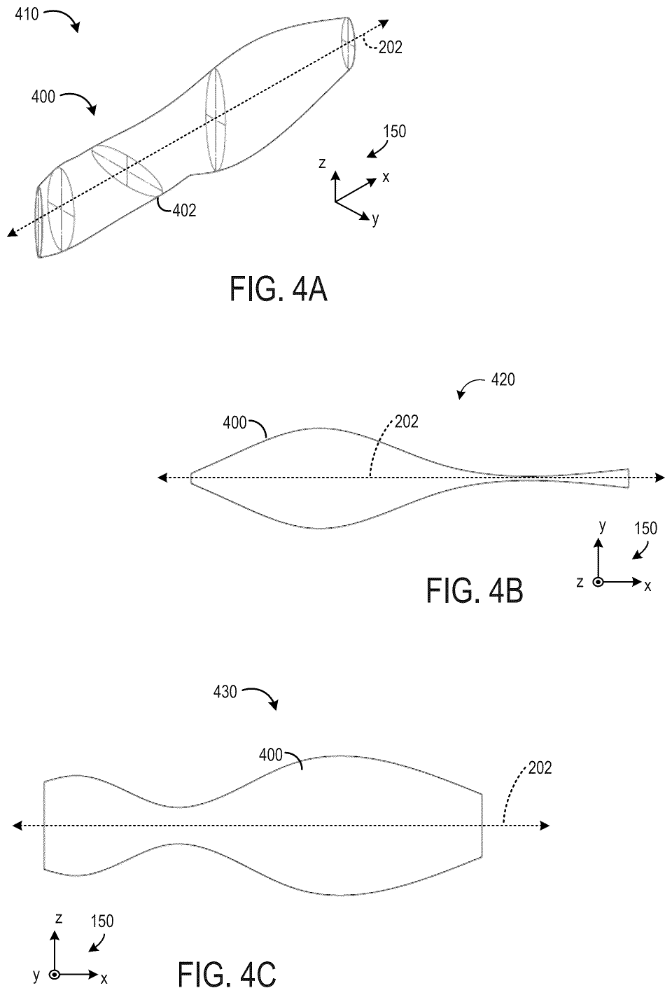

Turning to FIGS. 4A, 4B, and 4C, another example of a lure body 400 is shown in perspective view 410, top view 420, and side view 430, respectively. The lure body 400 may include oval shaped-cross sections, as shown. For example, the cross sections may be elliptical. In other examples, the cross sections may be other rounded shapes. Similar to the lure body 200 and the lure body 300 of FIGS. 2A-2D and FIGS. 3A-3C, respectively, the lure body 400 comprises oval-shaped (e.g., elliptical) or other rounded shaped cross sections. Further, in the side view 430, the body 400 has similar end shapes to the body 200 and the body 300, with ends being tapered, or more narrow than at least part of the midsection between the ends. However, the lure body 400 includes a widening (e.g., expansion in a y-direction) at an area such that a maximal diameter of cross section 402 is perpendicular with maximal diameters of other cross sections in y-z planes. In this way, the body 400 is narrower in the z-direction at the area. From any view perpendicular to the x-axis, the central axis 202 may be an axis of symmetry. Like the lure body 200 of FIGS. 2A-2D and the lure body 300 of FIGS. 3A-3C, the central axis 202 extends straight through a center of the lure body 400. Thus, the lure body 400 may be described herein as unbent. An unbent, untwisted lure body such as the lure body 400 may not be flat and instead comprise local widenings, or wings. However, the edges of the lure body 400 do not curve in a helical or spiral shape, and thus the lure body 400 may be referred to as an untwisted lure body similar to the examples provided in FIGS. 2A-3C.

A fish-shaped body such as the body 200, 300, or 400 of FIG. 200, 300, or 400 may be modified to form a lure of the present disclosure. As described above, a lure of the present disclosure may include one or more bends and/or one or more twists. As used herein, a bend may include a distortion from an unbent body (e.g., lure body 200, 300, or 400 of FIGS. 2A-2D, 3A-3C, and 4A-4D, respectively) such that a central axis (e.g., central axis 202 of FIGS. 2A-4D) is nonlinear (e.g., curved into an arc shape or otherwise deformed from a linear shape into a nonlinear shape). As used herein, a twist may include a distortion from an untwisted body (e.g., lure body 200, 300, or 400 of FIGS. 2A-2D, 3A-3C, and 4A-4D, respectively) where portions of outer edges are rotated about the central axis to form spiraled or helical edges and a twisted ribbon or corkscrew shape. The outer edges may spiral about a central axis. Additionally or alternatively, the oval-shaped cross sections may be oriented with alignment spiraled about the central axis. For example, alignment of maximal diameters of the oval-shaped cross sections may be nonparallel such that the oval-shaped cross sections form a spiral. The example unbent, untwisted lure bodies described above may be bent and/or twisted to form a bent and/or twisted lure body in accordance with the present disclosure. In this way, movement of the lure in the water may be adjusted by selecting a lure body shape with bends and/or twists to increase fish attraction to the lure.

Turning to FIGS. 5A, 5B, 5C, and 5D, an example of a twisted lure body 500 is shown in perspective view 510, top view 520, side view 530, and cross section view 540, respectively. The lure body 500 may include cross sections in y-z planes, such as section A-A, section B-B, section C-C, section D-D, and section E-E shown in FIG. 5D. The lure body 500 may include oval shaped-cross sections, as shown. For example, the cross sections may be elliptical. In other examples, the cross sections may be other rounded shapes. The lure body 500 may be the shape of the lure body 200 twisted about the central axis 202 to produce a twisted ribbon or corkscrew shape, and thus may be described herein as a twisted lure body. The twist may not change dimensions of cross sections perpendicular with the axis about which the body is twisted (e.g., oval-shaped cross sections). Further, in contrast with an untwisted lure body such as the lure bodies 200, 300, and 400 of FIGS. 2A-2D, FIGS. 3A-3C, and FIGS. 4A-4D, respectively, a twisted lure body such as the lure body 500 may include one or more helix or spiral shaped edges, such as a first edge 502 and a second edge 504. The edges may be defined by maximal diameters of the cross sections (e.g., oval-shaped cross sections in yz-planes). The edges may be spiraled about the central axis 202. Like the untwisted unbent lure bodies 200 and 300 of FIGS. 2A-2D and FIGS. 3A-3D, respectively, the twisted lure body 500 is centered about the central axis 202 extending straight through center points in y-z plane cross sections and thus may be described herein as an unbent lure body. The central axis 202 may be a straight line extending from a center of a first end 506 of the body 500 to a center of a second end 508 of the body 500. Thus, the lure body 500 may be referred to herein as an unbent, twisted lure body.

Turning to FIGS. 6A, 6B, and 6C, another example of a twisted lure body 600 is shown in perspective view 610, top view 620, and side view 630, respectively. The lure body 600 may include oval shaped-cross sections, as shown. For example, the cross sections may be elliptical. In other examples, the cross sections may be other rounded shapes. A first portion 606 of the lure body 600 may be untwisted and a second portion 608 of the lure body may be twisted, as evinced by a first edge 602 and a second edge 604. Like the first edge 502 and the second edge 504 of the body 500 in FIGS. 5A-5D, the first edge 602 and the second edge 604 may be defined by maximal diameters of the cross sections. For example, the edges may interest ends of the maximal diameters. Thus, a twisted lure body may be a lure body where at least a portion of the lure body is twisted to form a twisted ribbon or corkscrew shape with helical or spiral edges, making a fraction, a full, or multiple rotations about the central axis 202.

Turning to FIGS. 7A, 7B, 7C and 7D, an example of a bent twisted lure body 700 is shown in perspective view 710, top view 720, side view 730, and cross section view 740, respectively. The bent twisted lure body 700 may be produced by bending the twisted lure body 500 about a point spaced away from the body 700 such that the central axis 202 extending through the body 700 is nonlinear (e.g., curved into an arc shape or other nonlinear shape). The central axis 202 may be perpendicular to oval-shaped shaped cross sections. A line 702 extending from a center of a first end 704 and a center of a second end 706 may discontinuously extend through a bent lure body, such as the body 700. Discontinuously extending through the bent lure body may include a line that extends through both the bent lure body material and an outside of the bent lure body. In other words, the line 702 may extend through an area outside of the body 700. In contrast, a central axis of an unbent lure body may be collinear with the line 702 extending from the center of the first end 704 to the center of the second end 706. Further, in some examples, a second bend may be centered about a second point, a third bend may be centered about a third point, and so on such that a bent lure body of the present disclosure includes one or more bends in one or more directions. A radius of curvature of the central axis 202 may vary along the central axis 202 for a bent lure body. In other words, some portions of a bent lure body may be more bent than others. In some examples, some portions of the bent lure body may not be bent at all. However, in other examples, the central axis 202 may follow a circular arc with even radius of curvature along the bent lure body. In yet other examples, the central axis may be bent sharply or otherwise deformed from linearity, additionally or alternatively to being curved.

Turning to FIGS. 8A, 8B, 8C, and 8D, another example of a bent twisted lure body 800 is shown in perspective view 810, top view 820, side view 830, and second side view 840, respectively. Like the body 700 of FIGS. 7A-7D, the body 800 may include at least one bend forming a nonlinear shape (e.g., an arc shape) such that the central axis 202 is nonlinear (e.g., curved). The line 702 may discontinuously extend through a bent lure body, such as the body 800. The bent twisted lure body 800 may be produced by bending the twisted lure body 600 about a point spaced away from the body 800 such that the central axis 202 extending through the body 800 is nonlinear (e.g., curved and/or otherwise deformed from a straight line). The body 800 may include at least a portion with a twist such that edges spiral about the central axis 202. In some examples, there may be a full rotation of the edge about the central axis 202. In other examples, there may be more or less rotation of a twist. Like the lure body 700 of FIGS. 7A-7D, the radius of curvature of the central axis 202 may vary along the central axis 202 such that some portions of the body 800 are more bent than others.

A lure body profile may take a variety of shapes according to a desired fish resemblance (e.g., fish-shaped body) and movement pattern in water. There may be one or more bends in a lure body of the present disclosure, as described above with regards to FIGS. 7A-8D. Additionally or alternatively, there may be one or more twists in a lure body of the present disclosure, as described with regards to FIGS. 5A-6C. Further, as described above, a plurality of holes, including through holes, blind holes, cavities, and the like, may be formed into a twisted and/or bent lure body, such as the examples provided in FIGS. 5A-8D, to form a lure in accordance with the present disclosure. For example, the plurality of holes may include a leader hole, a tube, scent windows, and a ballast void, as described further below in regards to FIGS. 9A-12C. As an example, the holes are shown in FIGS. 9A-12D formed into the bent twisted lure body 700 of FIGS. 7A-7D. However, the holes may be formed into any other form of bent and/or twisted lure body with positions and shapes adjusted accordingly to form a lure in accordance with the present disclosure. The lure may be integrally formed as a single continuous piece. For example, the lure may be three-dimensional (3D) printed. Accordingly, the lure may be constructed of plastic, or another material conducive to 3D printing. However, other materials may be used in other examples to form a lure of the present disclosure comprising and twisted and/or bent lure body with a plurality of holes extending therethrough.

The plurality of holes may include a leader hole adapted to receive a leader where the lure may rotate about the leader hole. Turning to FIGS. 9A, 9B, 9C, and 9D, an example of a leader hole 900 is shown in perspective view 910, top view 920, side view 930, and cross section view 940, respectively. The leader hole 900 may be a through hole extending from a first opening 902 at a first location on a surface of the body 700, through the body 700, to a second opening 904 at another location on the surface. In this way, a leader, such as a length of fishing line, may extend through the leader hole, from the first opening 902 to the second opening 904. The leader hole 900 may be bent in some examples. In other examples, the leader hole 900 may be straight, as shown in FIGS. 9A-9C. For example, the leader hole 900 may extend approximately parallel with the central axis 202. The shape of the leader hole 900 may be selected according to a type of leader or desired rotation of the lure about the leader. The first opening 902 and the second opening 904 may be in any locations on the body 700. Further, the first opening 902 and the second opening 904 may take various shapes, such as circular, elliptical, or the like. Likewise, a cross section of the leader hole may be circular, elliptical, or the like. In at least some examples, the cross sections of the leader hole 900 may be the same shape and size along a length of the leader hole 900, as shown in FIG. 9D. However, the leader hole 900 may vary in shape or size in other examples. Further still, the first opening 902 and the second opening 904 may facilitate and support hardware such as hooks, beads, and the like.

The plurality of holes may further include a tube adapted to receive bait or weighted pellets. Turning to FIGS. 10A, 10B, 10C, and 10D, an example of a tube 1000 is shown in perspective view 1010, top view 1020, side view 1030, and cross section view 1040, respectively. Like the leader hole 900 of FIGS. 9A-9D, the tube may include a through hole 1006 extending through the body 700 between a first opening 1002 and a second opening 1004, where the first opening 1002 and the second opening 1004 may be positioned at any position on a surface of the body 700 and the through hole 1006 may be bent (e.g., nonlinear) or straight (e.g., linear). The tube 1000 may further include an internal cavity 1008. In this way, a greater volume of bait may be positioned within the lure of the present disclosure.

The tube 1000 may be converted to a weight tube by terminating ends of the through hole 1006. For example, a weight tube may be formed by first sealing the first opening 1002, then adding weights such as pellets via the second opening 1004, and finally sealing the second opening 1004. In this way, a weight of the lure may be adjusted in order to cast as desired. Thus, the tube may be sealed at the first opening 1002 and the second opening 1004 in at least some examples.

The plurality of holes may further include scent windows exposing the tube to outside of the lure. Turning to FIGS. 11A, 11B, and 11C, an example of scent windows 1100 is shown in perspective view 1110, top view 1120, side view 1130, and cross section view 1140, respectively. The scent windows 1100 may be orifices fluidically connecting the tube 1000 with an area outside of the body 700. For example, as shown in section C-C in FIG. 11D, a first scent window 1102 and a second scent window 1104 may extend between a surface of the body 700 and the tube 1000. In this way, water exposure to the bait may be increased, thereby increasing dispersion of a scent of the bait to attract more fish to the lure. Further, there may be more scent windows 1100, including a third scent window 1106, a fourth scent window 1108, a fifth scent window 1112, and a sixth scent window 1114. The scent windows 1100 may be arranged according to a geometry of the body 700 and placement of other holes, such that the scent windows extending between the tube 1000 and the surface without intersecting the other holes formed in the body, such as the leader hole 900 of FIGS. 9A-9D. In this way, the scent windows 1100 may connect the outside of the body 700 with inside of the tube 1000 such that scents from bait placed within the tube 1000 may travel outside of the body 700 to attract fish.

The plurality of holes may further include a ballast void comprising one or more closed cavities containing a less dense material compared to the body to selectively increase buoyancy and counteract uneven mass distribution due to placement of other holes. Turning to FIGS. 12A, 12B, 12C, and 12D, an example of a ballast void 1200 is shown in perspective view 1210, top view 1220, side view 1230, and cross section view 1240, respectively. The ballast void 1200 may include one or more closed cavities in the body 700, such as a first ballast void 1202 and a second ballast void 1204. The ballast void 1200 may be sealed such that the cavities permanently trap air therein. The ballast void 1200 may contain air or another material less dense than the body material (e.g., plastic). By containing a lighter weight material, the ballast void may act as a counter balance against added weight due to materials positioned in the body 700, for example a leader in a leader hole (e.g., leader hole 900 of FIGS. 9A-9D) and bait or weights in the tube (e.g., tube 1000 of FIGS. 10A-10D). The ballast void 1200 may add buoyancy to counteract mass imbalance (e.g., uneven mass distribution about the leader hole) imposed by such materials, thereby enhancing rotation of the lure about the leader extending through the leader hole. For example, an uneven mass distribution about the leader hole may be countered by additional buoyancy in the ballast void locations. Thus, the ballast void 1200 may be positioned and shaped according to a desired buoyancy effect. For example, the ballast void 1200 may include elongated, round shaped closed cavities as shown in FIGS. 12A-13D. The ballast void 1200 may include one or more closed cavities, where the ballast void is separated from other holes, including the leader hole 900 of FIGS. 9A-9D, the tube of FIGS. 10A-10D, and the scent windows 1100 of FIGS. 11A-11D. However, the ballast void 1200 may be shaped, sized, and placed otherwise according to a shape of the body 700 and desired rotational balance about the leader hole. Further, the ballast void 1200 may be shaped, sized, and positioned according to other holes, such as the leader hole, the tube, and other holes described herein so as not to intersect such holes. In this way, the ballast void 1200 may be spaced away and hermetically sealed from other spaces (e.g., holes in the body 700 and areas outside of the body 700) by walls of the body 700 therebetween. In at least some examples, the ballast void 1200 may be located in close proximity to the tube 1000 in order to balance bait or other materials positioned (and in some cases sealed) inside the tube 1000. For example, increased weight induced by materials in the tube 1000 may be counterbalanced by increased buoyancy provided by the ballast void 1200. In this way, rotation of the body about the leader hole may be increased due to buoyancy contribution to rotational balance. In some examples where weight balancing is not demanded, the ballast void 1200 may be omitted from a lure in accordance with the present disclosure.

As described above, a lure of the present disclosure may include all of the types of holes described with regards to FIGS. 9A-12D, in at least some examples. For example, turning to FIGS. 13A, 13B, 13C, and 13D, an example of a lure 1300 in accordance with the present disclosure is shown in perspective view 1310, top view 1320, side view 1330, and cross section view 1340, respectively. The lure 1300 comprises the body 700 and a plurality of holes including the leader hole 900 of FIGS. 9A-9D, the tube 1000 of FIGS. 10A-10D, the scent windows 1100 of FIGS. 11A-11D, and the ballast void 1200 of FIGS. 12A-12D. The lure 1300 may be 3D printed, in at least some examples. The lure 1300 may be a single continuous piece in at least some examples.

Turning to FIGS. 14A and 14B, a first example 1410 and a second example 1420 are respectively shown of a leading edge 1400 of the lure 1300. In some examples, the leading edge 1400 may be oval-shaped, such as shown in FIG. 14A. In other examples, the leading edge 1400 may be modified as shown in FIG. 14B. For example, the leading edge 1400 may have an organic curved shape rather than elliptical. Additionally, the leading edge 1400 may have a chamfered or beveled area 1402 such that degradation during use of the lure is reduced and fluid may more easily flow around the leading edge 1400. Further, the leading edge may include a notch or indent 1404. The leading edge 1400 may take other shapes than the examples shown in FIGS. 14A and 14B without departing from the scope of the present disclosure.

Turning to FIG. 15, an enlarged view 1510 of portion H depicted FIG. 13D is shown. The leader hole 900 may be shielded, or separated from, the tube 1000 and other holes. For example, a wall 1502 of the body 700 may extend between the leader hole 900 and the tube 1000. In this way, the leader hole 900 may be shielded from the tube 1000 by the wall 1502 therebetween. The wall 1502 may maintain a cross section of the leader hole 900. For example, the leader hole 900 is shown having circular cross section and the tube 1000 is shown having circular cross section, where the wall cuts into the tube 1000 cross section and maintains the cross section shape of the leader hole 900. The wall 1502 may extend into the tube 1000 to maintain a cross section shape (e.g., circular cross section shape) of the leader hole. In this way, separation between the leader hole 900 and the tube 1000 may be achieved where intersection between the leader hole and the tube 1000 would otherwise occur. The wall 1502 may be of an even thickness 1504, where the thickness is selected above a threshold to prevent degradation of the wall 1502. The wall 1502 may prevent intersection between the tube 1000 and the leader hole 900 such that bait, weighted pellets, or other materials placed within the tube do not interact with a leader positioned in the leader hole. In this way, the materials placed within the tube 1000 may not interfere with the leader hole, and thus rotation of the lure about the leader may not be undesirably affected by the materials in the tube. Thus, movement, and particularly spinning, of the lure may be improved by separation of the leader hole 900 from other holes, in addition to a shape of the body including twists and/or bends.

The technical effect of the fishing lure disclosed herein is to increase fish attraction to the lure and reduce complexity of the lure, thereby reducing resource demand for manufacturing and likelihood of degradation. For example, a body including a twist and/or bend may allow the lure to move and spin in a way such that fish are more attracted to the lure. Further, the lure may be constructed of a single piece such that hinges, snap-fittings, and the like are not demanded to place bait or other materials inside of the lure. Further still, the plurality of holes formed in the lure body may be oriented to avoid intersection. For example, the leader hole is separated from the tube so that bait or weighted pellets positioned in the tube do not interfere with rotation of the lure about the leader positioned in the leader hole. In this way, spinning may be further increased, thereby increasing an effectiveness of the lure in attracting fish thereto.

The disclosure also provides support for a fishing lure, comprising: a body with oval-shaped cross sections centered along a central axis, where the body is twisted in shape such that edges of the body and/or alignment of the oval-shaped cross sections are spiraled. In a first example of the system, the system further comprises: a plurality of holes formed into the body. In a second example of the system, optionally including the first example, a central axis extends linearly from a center of a first end to a center of a second end. In a third example of the system, optionally including one or both of the first and second examples, the edges are defined by maximal diameters of the oval-shaped cross sections. In a fourth example of the system, optionally including one or more or each of the first through third examples, the plurality of holes includes a leader hole shaped as a through hole extending from a first opening to a second opening, and wherein the fishing lure is adapted to rotate about the leader hole. In a fifth example of the system, optionally including one or more or each of the first through fourth examples, the leader hole extends parallel with the central axis. In a sixth example of the system, optionally including one or more or each of the first through fifth examples, the plurality of holes further includes a tube spaced away and fluidically separated from the leader hole by a wall of the body therebetween. In a seventh example of the system, optionally including one or more or each of the first through sixth examples, scent windows connect the tube with an outside of the fishing lure. In an eighth example of the system, optionally including one or more or each of the first through seventh examples, the wall maintains the shape of the leader hole and cuts into the tube to prevent intersection of the leader hole with the tube.

The disclosure also provides support for a fishing lure, comprising: a fish-shaped body twisted about a central axis extending through centers of cross sections of the body into a corkscrew shape and bent such that the central axis is nonlinear. In a first example of the system, the system further comprises: a plurality of holes including closed cavities and through holes, wherein the plurality of holes is formed into the body such that the fishing lure is a single continuous piece. In a second example of the system, optionally including the first example, the plurality of holes includes a leader hole about which the fishing lure is adapted to rotate, and wherein other holes do not intersect the leader hole. In a third example of the system, optionally including one or both of the first and second examples, the plurality of holes includes a ballast void including one or more closed cavities containing a less dense material than the body and positioned to counteract uneven mass distribution about the leader hole for rotational balance. In a fourth example of the system, optionally including one or more or each of the first through third examples, the plurality of holes includes a tube separated from the leader hole by a wall extending into the tube to maintain a cross section shape of the leader hole. In a fifth example of the system, optionally including one or more or each of the first through fourth examples, the plurality of holes includes scent windows fluidically connecting the tube with a surface of the body. In a sixth example of the system, optionally including one or more or each of the first through fifth examples, the fish-shaped body has oval-shaped cross sections of varying dimensions forming tapered ends.

The disclosure also provides support for a fishing lure, comprising: a body with oval-shaped cross sections, where the body is bent to form a nonlinear shape such that a line between a first end of the body and a second end of the body extends discontinuously through the body, a tube extending through the body between a first opening and a second opening, and a leader hole extending through the body and shielded from the tube by a wall of the body therebetween. In a first example of the system, maximal diameters the oval-shaped cross sections are parallel such that the body is untwisted. In a second example of the system, optionally including the first example, edges of the body defined by maximal diameters of the oval-shaped cross sections spiral about a nonlinear central axis extending through centers of the oval-shaped cross sections such that the body is twisted. In a third example of the system, optionally including one or both of the first and second examples, a radius of curvature of the nonlinear shape varies along the body. In a fourth example of the system, optionally including one or more or each of the first through third examples, the system further comprises: one or more scent windows connecting the tube with a surface of the body and a ballast void comprising one or more closed cavities separated from the tube, the leader hole, and the one or more scent windows. In a fifth example of the system, optionally including one or more or each of the first through fourth examples, the tube is sealed at the first opening and the second opening.

FIGS. 1A-15 are shown approximately to scale; though other relative dimensions may be used. As used herein, the terms “approximately” is construed to mean plus or minus five percent of the range unless otherwise specified.

If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. Moreover, the components may be described as they relate to reference axes included in the drawings.

Features described as axial may be approximately parallel with an axis referenced unless otherwise specified. Features described as counter-axial may be approximately perpendicular to the axis referenced unless otherwise specified. Features described as radial may circumferentially surround or extend outward from an axis, such as the axis referenced, or a component or feature described prior as being radial to a referenced axis, unless otherwise specified.

Features described as longitudinal may be approximately parallel with an axis that is longitudinal. A lateral axis may be normal to a longitudinal axis and a vertical axis. Features described as lateral may be approximately parallel with the lateral axis. A vertical axis may be normal to a lateral axis and a longitudinal axis. Features described as vertical may be approximately parallel with a vertical axis.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A fishing lure, comprising:
a body with oval-shaped cross sections, where the body is twisted in shape such that edges of the body and/or alignment of the oval-shaped cross sections are spiraled.

2. The fishing lure of claim 1, further comprising a plurality of holes formed into the body.

3. The fishing lure of claim 1, wherein a central axis extends linearly from a center of a first end to a center of a second end.

4. The fishing lure of claim 1, wherein the edges are defined by maximal diameters of the oval-shaped cross sections.

5. The fishing lure of claim 2, wherein the plurality of holes includes a leader hole shaped as a through hole extending from a first opening to a second opening, and wherein the fishing lure is adapted to rotate about the leader hole.

6. The fishing lure of claim 5, wherein the leader hole extends parallel with a linear central axis.

7. The fishing lure of claim 5, wherein the plurality of holes further includes a tube spaced away and fluidically separated from the leader hole by a wall of the body there between.

8. The fishing lure of claim 7, wherein scent windows connect the tube with an outside of the fishing lure.

9. The fishing lure of claim 7, wherein the wall maintains the shape of the leader hole and cuts into the tube to prevent intersection of the leader hole with the tube.

10. A fishing lure, comprising:
a fish-shaped body twisted about a central axis extending through centers of cross sections of the body into a corkscrew shape and bent such that the central axis is nonlinear.

11. The fishing lure of claim 10, further comprising a plurality of holes including closed cavities and through holes, wherein the plurality of holes is formed into the body such that the fishing lure is a single continuous piece.

12. The fishing lure of claim 11, wherein the plurality of holes includes a leader hole about which the fishing lure is adapted to rotate, and wherein other holes do not intersect the leader hole.

13. The fishing lure of claim 12, wherein the plurality of holes includes a ballast void including one or more closed cavities containing a less dense material than the body and positioned to counteract uneven mass distribution about the leader hole for rotational balance.

14. The fishing lure of claim 12, wherein the plurality of holes includes a tube separated from the leader hole by a wall extending into the tube to maintain a cross section shape of the leader hole.

15. The fishing lure of claim 14, wherein the plurality of holes includes scent windows fluidically connecting the tube with a surface of the body.

16. The fishing lure of claim 10, wherein the fish-shaped body has oval-shaped cross sections of varying dimensions forming tapered ends.

17. A fishing lure, comprising:
a body with oval-shaped cross sections, where the body is bent to form a nonlinear shape such that a line between a first end of the body and a second end of the body extends discontinuously through the body;
a tube extending through the body between a first opening and a second opening; and
a leader hole extending through the body and shielded from the tube by a wall of the body therebetween.

18. The fishing lure of claim 17, wherein maximal diameters the oval-shaped cross sections are parallel such that the body is untwisted.

19. The fishing lure of claim 17, wherein edges of the body defined by maximal diameters of the oval-shaped cross sections spiral about a nonlinear central axis extending through centers of the oval-shaped cross sections such that the body is twisted.

20. The fishing lure of claim 17, wherein a radius of curvature of the nonlinear shape varies along the body, the lure further comprising one or more scent windows connecting the tube with a surface of the body and a ballast void comprising one or more closed cavities separated from the tube, the leader hole, and the one or more scent windows, wherein the tube is sealed at the first opening and the second opening.
